(19) United States
(12) Patent Application Publication
(10) Pub. No.: US 2014/0203548 A1
(43) Pub. Date: Jul. 24, 2014

(54) ELECTRICAL SWITCHGEAR UNIT

(71) Applicants: Gerrit Boehm, Baunatal (DE); David Kraft, Staufenberg (DE)

(72) Inventors: Gerrit Boehm, Baunatal (DE); David Kraft, Staufenberg (DE)

(73) Assignee: ALSTOM GRID GMBH, Kassel (DE)

(21) Appl. No.: 14/239,604

(22) PCT Filed: Jul. 19, 2012
(86) PCT No.: PCT/EP2012/064163

§ 371 Date: Feb. 19, 2014

(30) Foreign Application Priority Data
Sep. 5, 2011 (EP) 11180093.4

(51) Int. Cl. H01H 33/56; H02B 13/045; F16L 25/00

(52) U.S. Cl. CPC H01H 33/565; F16L 25/0054; H02B 13/045
USPC 285/231

(57) ABSTRACT

An embodiment of the invention relates to an electrical switchgear unit, in particular a high voltage switchgear unit. A housing is present, which is provided with a housing wall which contains a bore. A corrugated tube is present, which is coupled to the bore. For this purpose, the corrugated tube is plugged into the bore. Between the corrugated tube and the bore, an annular gap is located, in which an O ring is arranged, which is plugged onto the corrugated tube.

### PRIORITY STATEMENT

This application is the national phase under 35 U.S.C. §371 of PCT International Application No. PCT/EP2012/064163 which has an International filing date of Jul. 19, 2012, which designated the United States of America, and which claims priority to European patent application number EP 11180093.4 filed Sep. 5, 2011, the entire contents of each of which are hereby incorporated herein by reference.

### FIELD

At least one embodiment of the invention generally relates to an electrical switchgear unit.

### BACKGROUND

An electrical switchgear unit is known, for example, from the DE 10 2007 016 720 A1. FIG. 1 therein shows the crankcases for three power switch or circuit breaker poles belonging to a high-voltage switchgear unit filled with insulating gas. These crankcases are connected via tubular connections, so as to be gas-tight.

The practice of using a pre-bent copper tube for the tubular connection is known. Fittings or the like can be provided for connecting the copper tube to a bore in a wall of the crankcase housing.

The copper tube can be provided, for example, with a beading at the end and with a coupling ring. A connecting piece onto which a coupling ring can be screwed is screwed into a threaded bore contained in the housing wall. A cylindrical adapter with an O-ring fitted onto it is arranged between the beading on the copper tube and the connecting piece. The O-ring serves to provide a gas-tight connection between the beading on the copper tube and the connecting piece. For this, it is necessary to produce the beading on the copper tube with high precision and so as to be reproducible. It is obvious that the complete, above-described procedure requires a high expenditure and is therefore cost-intensive.

Furthermore known is the use of a corrugated tube for the tubular connection. For the purpose of coupling the corrugated tube to a bore in a housing wall of the crankcase, corresponding fittings can be provided in that case.

For example, it is possible to first cut the corrugated tube to the desired length and to push a coupling ring onto the corrugated tube. The cut end of the corrugated tube is then processed with a special tool. In particular, the cutting surface on the corrugated tube is deburred with the aid of a special tool and is compressed to form a beading. A clamping ring is then inserted into a trough of the corrugated tube. Following this, the corrugated tube is screwed together with a connecting piece which is screwed into the housing wall. An O-ring is inserted between the exposed end of the corrugated tube and the adapter, so as to be provided a gas-tight connection between the corrugated tube and the connecting piece. It is necessary in that case to produce the beading with high precision and to ensure that the cutting surface on the corrugated tube does not contain any burrs. The above-described procedure is thus obviously very involved and tied to high costs.

### SUMMARY

At least one embodiment of the invention is directed to an electrical switchgear unit for which the tube connections can be produced easier.

An electrical switchgear unit is disclosed in at least one embodiment.

Provided in an embodiment is a housing with a housing wall containing a bore. Also provided is a corrugated tube that is coupled to the bore, wherein the corrugated tube is inserted into the bore. An annular gap with therein arranged O-ring that is fitted onto the corrugated tube remains between the corrugated tube and the bore.

### BRIEF DESCRIPTION OF THE DRAWINGS

Additional features, options for use and advantages of the invention follow from the description below of example embodiments of the invention which are shown in the Figures of the drawing. All features described or shown herein, either by themselves or in any combination thereof, form the subject matter of the invention, regardless of how they are combined in the patent claims or the references back, as well as independent of the formulation and/or representation in the description and/or in the drawing.

FIG. 1 shows a schematic sectional view of a first example embodiment of a section of an electrical switchgear unit with a corrugated tube inserted into a housing wall of the switchgear unit.

FIG. 2 shows a second and corresponding example embodiment.

### DETAILED DESCRIPTION OF THE EXAMPLE EMBODIMENTS

Provided in an embodiment is a housing with a housing wall containing a bore. Also provided is a corrugated tube that is coupled to the bore, wherein the corrugated tube is inserted into the bore. An annular gap with therein arranged O-ring that is fitted onto the corrugated tube remains between the corrugated tube and the bore.

No fittings or the like are required for embodiments of the invention. Instead, the cut end of the corrugated tube is inserted together with the thereon fitted-on O-ring into the bore. A tube connection is thus created which requires low structural and production-technical expenditure and which can be mounted easily and cost-effectively. In particular, no special tools or the like are required for processing the corrugated tube.

According to one advantageous embodiment of the invention, the dimensions of the corrugated tube, the bore, and the O-ring are matched to each other in such a way that a gas-tight connection is created between the bore and the corrugated tube. An involved sealing of the axial cutting surfaces of the corrugated tube is therefore not required. Instead, the required seal is achieved through a tight fit of the O-ring around the circumference of the corrugated tube and inside the bore. The seal provided according to the invention along the circumference of the corrugated tube insofar differs advantageously from the known seal provided along the cut surface of the corrugated tube.

It is particularly advantageous if the O-ring is fitted onto a wave trough of the corrugated tube. As a result, an especially tight seal can be achieved.

According to one advantageous embodiment of the invention, a bushing is arranged in the annular gap. This bushing can essentially either fill the annular gap completely or only partially. In the second case, a second O-ring can be fitted onto a “free” wave trough of the corrugated tube. The O-ring or the O-rings is/are essentially secured locally with the aid of the bushing.

One advantageous modification of an embodiment the invention provides for a tab washer that engages in a wave trough of the corrugated tube and is attached to the housing. The corrugated tube and the O-ring/rings are essentially secured locally with the aid of the tab washer.

An electrical switchgear unit, for example a high-voltage switchgear unit, can comprise a number of power switch poles or disconnecting switch poles or the like. These switchgear poles are assigned to crankcases in which the driving mechanisms for the respective switchgear poles are housed. Tubular connections that are coupled to the switchgear poles and/or to the crankcases are provided, for example, for monitoring the pressure acting upon an insulating gas. The switchgear poles, the crankcases and the tubular connections are filled with insulating gas. For a more detailed explanation of electrical switchgear units of this type we point, for example, to the document DE 10 2007 016 720 A1.

We expressly point out that the electrical switchgear unit can furthermore refer to any other type of metal-encapsulated switchgear unit or to an outdoor switchgear unit.

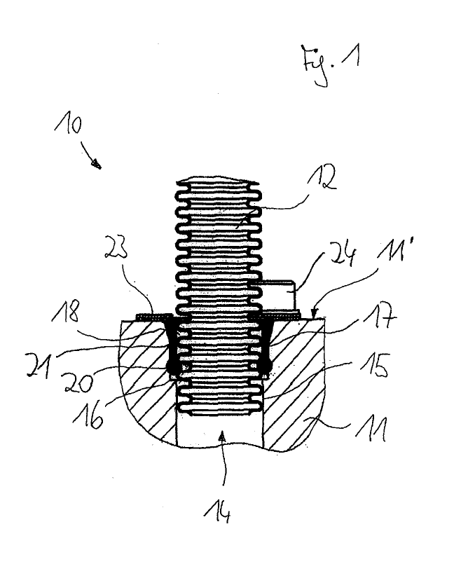

FIG. 1 shows a housing wall 11 for an electrical switchgear unit 10. For example, this housing wall 11 can be a component of a crankcase for a switchgear pole for the electrical switchgear unit 10.

However, we expressly point out that the housing wall 11 can also be a component of any other type of housing or housing part, or can belong to a different component of the electrical switchgear unit 10. For example, this housing can also refer to one of several gas-filled compartments for a metal-encapsulated switchgear unit.

The housing wall 11 and/or the associated housing are preferably composed of metal.

A corrugated tube 12 is furthermore shown in FIG. 1 which can, for example, be a component of a tubular connection filled with insulating gas for the electrical switchgear unit 10. The corrugated tube 12 is embodied flexible and can consist, for example, of a corrosion-resistant metal alloy.

A cylindrical bore 14 is provided in the housing wall. The bore 14 is oriented approximately perpendicular to the surface 11′ of the housing wall 11. In a region 15, the bore 14 has a diameter that is at least as large or slightly larger than the outside diameter of the corrugated tube 12. An offset 16 where the diameter changes is provided in the course of the bore 14. A region 17 with expanded diameter is thus created in the bore 14. This region 17 is located adjacent to the surface 11′ of the housing wall 11.

The corrugated tube 12 is embodied cylindrically and has the previously mentioned outside diameter at its wave crests. In the wave troughs, the diameter of the corrugated tube 12 is smaller than the outside diameter.

The corrugated tube 12 is inserted into the bore 14, meaning over the complete, expanded region 17 and extending up to the region 15 of the bore 14. In the region 15 of the bore 14, the corrugated tube 12 essentially rests with its wave crests against the inside surface of the bore 14 while in the expanded region 17 an annular gap 18 remains between the wave crests of the corrugated tube 12 and the inside surface of the bore 14.

An O-ring 20 is arranged in the ring-shaped gap 18, approximately adjacent to the offset 16. the O-ring 20 preferably consists of an elastic material, for example an elastomer or rubber. The O-ring 20 is fitted in the region of a wave trough onto the corrugated tube 12.

The dimensions of the corrugated tube 12 and in particular its outside diameter, the diameter for the region 17 of the bore 14, as well as the dimensions for the O-ring 20 are matched to each other in such a way that a gas-tight connection is created between the O-ring 20 and the bore 14 as well as between the O-ring 20 and the corrugated tube 12. This is synonymous with the O-ring 20 creating a gas-tight seal between the bore 14 and the corrugated tube 12.

A bushing 21 is arranged in the annular gap 18, meaning between the O-ring 20 and the surface 11′ of the housing wall 11. The bushing 21 can consist of a synthetic material or an elastomer, for example of rubber, but can also be made of metal. The axial length of the bushing 21 is dimensioned such that as seen in axial direction the annular gap 18 is filled at least for the most part or substantially by the bushing 21.

At least one tab washer 23 is arranged on the surface 11′ of the housing wall 11. The tab washer 23 can be embodied, for example, in the form of a semi-circular ring. The tab washer 23 engages at least partially in a wave trough of the corrugated tube 12. In this position, the tab washer 23 is fixedly coupled with the aid of a screw 24 to the housing wall 11.

The region 17 of the bore 14, which is arranged adjacent to the surface 11′ of the housing wall 11, can be provided with an insertion bevel. It means that the diameter of the region 17 in the direction toward the surface 11′ increases slightly. This insertion bevel facilitates the insertion of the corrugated tube 12 with the fitted-on O-ring 20 into the bore 14, thus making the assembly easier.

As previously explained, The O-ring 20 provides a gas-tight connection between the bore 14 and the corrugated tube 12. The O-ring 20 is essentially secured locally in the annular gap 18 with the aid of the bushing 21 and the tab washer 23. In particular, the O-ring 20 in the annular gap 18 cannot move in the direction toward the surface 11′ of the housing wall 11. The bushing 21 furthermore prevents dirt and, if applicable, also water from entering the annular gap 18. With the aid of the tab washer 23 that engages in a wave trough, the corrugated tube 12 is essentially secured inside the bore 14. In particular, the corrugated tube 12 cannot move out of the bore 14.

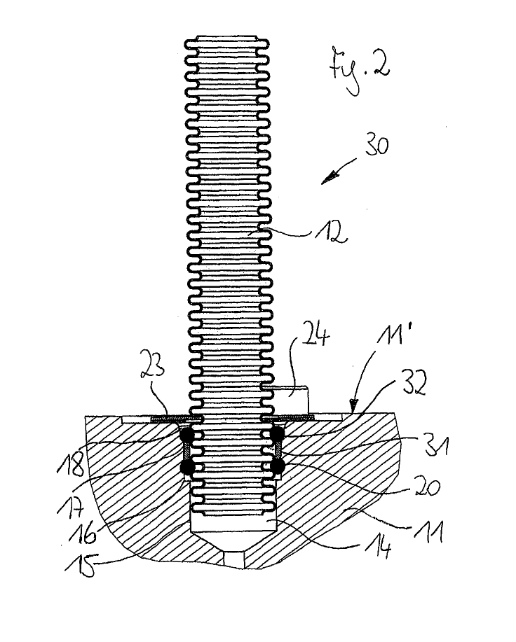

FIG. 2 corresponds for the most part to FIG. 1. The same components or features as shown in FIG. 1 are therefore also given the same references in FIG. 2. With respect to the description of these components and features, we refer fully to the above-provided explanations relating to FIG. 1.

As in FIG. 1, the O-ring 20 in FIG. 2 is also provided to create a gas-tight connection between the corrugated tube 12 and the bore 14. In contrast to FIG. 1, the bushing 21 from FIG. 1 has a different design in FIG. 2.

In FIG. 2, a bushing 31 is arranged inside the annular gap 18 which bushing does not completely fill the annular gap 18 in axial direction. Instead, the axial length of the bushing 31 is dimensioned such that adjacent to the surface 11′ of the housing wall 11, one wave trough of the corrugated tube 12 still remains “empty.” A second O-ring 32 is fitted in this wave trough onto the corrugated tube 12. This second O-ring 32 is consequently arranged inside the annular gap 18, meaning adjacent to the surface 11′ of the housing wall 11.

The first O-ring 20 and the second O-ring 32 are spaced apart in longitudinal direction in such a way that the distance substantially corresponds to the axial length of the bushing 31.

In a comparable manner to the first O-ring 20, it is also true for the second O-ring 32 that the dimensions of the corrugated tube 12, the diameter of the region 17 of the bore 14, including the possibly existing insertion bevel, as well as the dimensions of the O-ring 32 itself are matched to each other, such that at least one water-tight and dirt-tight connection is created between the O-ring 32 and the bore 14 on the one hand and the O-ring 32 and the corrugated tube 12 on the other hand.

If applicable, the second O-ring 32 can also be embodied such that a gas-tight connection is created, wherein the first O-ring 20 can be omitted in that case if necessary.

As previously explained, the two O-rings 20, 32—either by themselves or jointly —function to provide a gas-tight connection between the bore 14 and the corrugated tube 12. With the aid of the bushing 31, the second O-ring 32, and the tab washer 23 it is achieved that the first O-ring 20 is essentially locally secured inside the annular gap 18. In particular, the first O-ring 20 inside the annular gap 18 cannot move in the direction toward the surface 11′ of the housing wall 11. With the aid of the second O-ring 32, water and dirt are prevented from entering the annular gap 18. The second O-ring 32 in this case is essentially secured locally with the aid of the bushing 31 and the tab washer 23. The corrugated tube 12 is basically secured inside the bore 14 as a result of using the tab washer 23 that engages in a wave trough.

The example embodiments for coupling the corrugated tube 12 to the bore 14 of the housing wall 11, explained in the above with the aid of the aforementioned FIGS. 1 and 2, do not require any fittings or the like that need to be soldered on or welded on. The length of the corrugated tube 12 can be selected optionally in all cases and the corrugated tube 12 can be cut accordingly. The resulting, ring-shaped cutting surface of the corrugated tube 12 does not form a sealing surface in that case and therefore does not need to be processed further. Special tools or the like are not required. Instead, a wave trough of the corrugated tube is used for the sealing surface. A very simple and cost-effective assembly is that possible, which allows achieving a desired seal through a corresponding dimensioning of the O-ring(s) in an easy and cost-effective manner.

We want to point out that the above-described example embodiments for coupling the corrugated tube 12 to the bore 14 in the housing wall 11 need not absolutely be designed gas-tight. Instead, the above-described coupling options can in the same way also be used for cases where no insulating gas is present or where no gas-tight connection is required for other reasons.

1. An electrical switchgear unit, comprising,
a housing with a housing wall, provided with a bore and a corrugated tube coupled to the bore, wherein the corrugated tube is fitted into the bore, an annular gap being provided between the corrugated tube and the bore, and an O-ring, fitted onto the corrugated tube, being arranged in the annular gap.

2. The electrical switchgear unit of claim 1, wherein dimensions of the corrugated tube, the bore, and the O-ring are matched to each other such that a gas-tight connection is created between the bore and the corrugated tube.

3. The electrical switchgear unit of claim 1, wherein the O-ring is fitted onto a wave trough of the corrugated tube.

4. The electrical switchgear unit of claim 1, wherein a bushing is arranged in the annular gap.

5. The electrical switchgear unit of claim 4, wherein an axial length of the bushing is dimensioned such that the bushing at least mostly or essentially completely fills the annular gap, as seen in an axial direction.

6. The electrical switchgear unit of claim 4, wherein two O-rings are provided in the annular gap, the two O-rings being spaced apart in an axial direction, wherein the bushing is provided between the two O-rings and wherein an axial length of the bushing essentially corresponds to a distance between the two O-rings.

7. The electrical switchgear unit of claim 1, wherein a tab washer is provided which engages in a wave trough of the corrugated tube and is attached to the housing.

8. The electrical switchgear unit of claim 1, wherein the corrugated tube is embodied to be flexible.

9. The electrical switchgear unit of claim 1, wherein the O-ring is composed of an elastic material, in particular of an elastomer or rubber.

10. The electrical switchgear unit of claim 1, wherein the housing is a crankcase for a switchgear pole.

11. The electrical switchgear unit of claim 1, wherein the electrical switchgear unit is a high-voltage switchgear unit.

12. The electrical switchgear unit of claim 1, wherein the corrugated tube is composed of a corrosion-resistant metal alloy.

13. The electrical switchgear unit of claim 8, wherein the corrugated tube is composed of a corrosion-resistant metal alloy.

14. The electrical switchgear unit of claim 9, wherein the O-ring is composed of an elastomer or rubber.

15. The electrical switchgear unit of claim 6, wherein the O-rings are composed of an elastic material.

16. The electrical switchgear unit of claim 16, wherein the O-rings are composed of an elastomer or rubber.
